(19) United States
(12) Patent Application Publication
(10) Pub. No.: US 2022/0000235 A1
(43) Pub. Date: Jan. 6, 2022

(54) LUNCH BOX CONTAINER USABLE ON INDUCTION COOKTOP

(71) Applicant: KOVAX CO.LTD, Busan (KR)

(72) Inventor: Bong Je JO, Busan (KR)

(73) Assignee: KOVAX CO.LTD, Busan (KR)

(21) Appl. No.: 17/295,441

(22) PCT Filed: May 15, 2020
(86) PCT No.: PCT/KR2020/006460

§ 371 Date: May 20, 2021

(30) Foreign Application Priority Data
Jun. 3, 2019 (KR) 10-2019-0065163

(51) Int. Cl. A45C 11/20; A47J 36/24; B65D 1/24; A47J 36/02

(52) U.S. Cl. CPC A45C 11/20; A47J 36/02; B65D 1/24; A47J 36/24

(57) ABSTRACT

A lunch box container includes: a main container; and an auxiliary container configured to be accommodated in the main container, wherein the auxiliary container is made of a material heatable on an induction cooktop.

### CROSS REFERENCE TO THE RELATED APPLICATIONS

This application is the national phase entry of International Application No. PCT/KR2020/006460, filed on May 15, 2020, which is based upon and claims priority to Korean Patent Application No. 10-2019-0065163, filed on Jun. 3, 2019, the entire contents of which are incorporated herein by reference.

### TECHNICAL FIELD

The present disclosure relates generally to a lunch box container usable on an induction cooktop and which may be heated unwrapped.

### BACKGROUND

Hereinbelow, a related art will be described with reference to drawings.

Referring to FIGS. 1 to 3, a separable and heatable lunch box container set consists of a container part 100, a pouch 200 accommodating the container part 100, and a heating pack 300 that may heat the container part 100 in the pouch 200.

The container part 100 may be configured to contain various foods and store and take the foods outside, and includes a main container 110, an auxiliary container 120, and a cover portion 130.

A plurality of first main accommodating parts 111 is independently partitioned at a first side of the main container 110 so that various side dishes are separately put in the main container 110, and the first main accommodating parts 111 are formed to have different depths.

A second main accommodating part 112 is formed in a shape of a spoon and chopsticks so as to accommodate a spoon and chopsticks and is formed at a second side of the main container 110 with a predetermined depth and is independently partitioned-provided.

The auxiliary container 120 is extended from the first side of the main container 110, and has the first, second auxiliary accommodating portion 121, 122 in which food is put.

Perforated holes 140 are formed at a boundary between the auxiliary container 120 and the main container 110 so that the auxiliary container 120 may be separated from the main container 110.

The first, second auxiliary accommodating portion 121, 122 has a predetermined depth so as to separate rice and soup among the foods and is independently partitioned in the auxiliary container 120.

Cut induction grooves 141 curved toward the inside of the main container 110 and the auxiliary container 120 are respectively formed at opposite ends of the perforated holes 140, so that the auxiliary container 120 is easily separated from the main container 110 by the perforated holes 140.

The cover portion 130 is configured to cover upper portions of the main container 110 and the auxiliary container 120 so as to prevent separation of the foods in the main container 110 and the auxiliary container 120.

The cover portion 130 is fused to edges of the main container 110 and the auxiliary container 120.

The cover portion 130 may have the perforated holes 140 same as the perforated holes 140 formed at the main container 110, thereby being separated together when the auxiliary container 120 is separated from the main container 110.

The pouch 200 is configured to accommodate the auxiliary container 120 containing the rice and soup and to heat the auxiliary container 120 by the heating pack 300, and includes a main body 210, an open portion 220, and a sealed portion 230.

The main body 210 has an inner space 211 in which accommodating the auxiliary container 120 separated from the main container 110 by the perforated holes 140 and the heating pack 300.

The open portion 220 has a zipper 221 formed at an upper portion of the main body 210 and configured to open and close an upper portion of the space 211.

The sealed portion 230 has a perforated line 231, which is configured to seal a first end of the open portion 220 in a bonded state and to cut the first end of the open portion 220 in a direction from the first end to a second end of the open portion by a pulling force.

Cut grooves 232 are respectively formed at opposite sides of the sealed portion 230, so that the sealed portion 230 is easily separated along the perforated line 231.

The sealed portion 230 is configured to seal the space 211 so that the heating pack 300 provided in the space 211 of the main body 210 is safely stored inside the pouch 200 without escaping.

Open holders 240 are formed at opposite sides at an outer portion of the main body 210, so that the open portion 220 closed by the zipper 221 is opened to opposite directions.

The open holders 240 may prevent a burn accident caused by the main body 210 heated by the heating pack 300 and may open the open portion 220 safely.

A discharge hole 250 is formed at one side of the outer portion of the main body 210, so that steam generated by the heating pack 300 in the space 211 may be discharged outward.

A cover member 260 is provided at one end of the discharge hole 250 so as to cover the discharge hole 250.

The cover member 260 is configured to close the discharge hole 250 at start when the heating pack 300 is heated to increase heating efficiency of the heating pack 300.

The heating pack 300 is configured to be provided in the space 211 of the pouch 200 and to heat the auxiliary container 120 in the space 211, and in detail, to heat the auxiliary container 120 by steam of high temperature generated by reacting with water.

Hereinbelow, the separable and heatable lunch box container set will be described with reference to FIGS. 4 and 5.

A user separates the auxiliary container 120 from the main container 110 along the perforated holes 140.

Next, the open portion 220 of the pouch 200 is opened through the sealed portion 230, and the open portion 220 is opened to the opposite directions by the open holders 240.

The auxiliary container 120 is put in the space 211 of the pouch 200.

As an example, the auxiliary container 120 contains rice and soup, so the rice and soup may be selectively heated.

At this point, the heating pack 300 has been provided in the space 211, and the user fills a predetermined volume of water into the space 211 and then closes the open portion 220 by the zipper 221.

Then, the heating pack 300 reacts with water to create steam of high temperature, so the steam is filled inside the space 211 to heat the food in the auxiliary container 120.

The cover member 260 closes the discharge hole 250 to allow the steam to stay in the space 211 of the main body 210 for a predetermined time to increase the heating efficiency of the auxiliary container 120, and after the predetermined time, the cover member 260 opens the discharge hole 250 to discharge the seam in the space 211 outward.

After heating of the auxiliary container 120, the user pulls the open holders 240 to open the open portion 220 to the opposite directions, takes out the auxiliary container 120 from the space 211, and eats the warm heated food.

At this point, the open holders 240 prevents the user from suffering a burn accident caused by the main body 210 heated by the heating pack 300 and opens the open portion 220 safely.

Meanwhile, when food in the main container 110 is a side dish of meat and fish that need heating, the user can put the main container 110 in the space 211 of the pouch 200 together with the auxiliary container 120 to heat the main container 110 by the heating pack 300.

As described above, the separable and heatable lunch box container set is configured to separate the auxiliary container 120 from the main container 110 and then selectively heat food in the auxiliary container 120.

The user can separate the auxiliary container 120 from the main container 110 and selectively heat the separated auxiliary container 120 in the pouch 200 her or himself.

However, in the related art, there are disadvantages that the auxiliary container is separated from the main container and the food in the auxiliary container is selectively heated. Lunch boxes are generally provided to many people at one time, so the lunch boxes must be heated in a short time without unwrapping, and this is a disadvantage in the field.

There is disadvantage that a separate pouch is provided and provision of separate pouch incurs a lot of cost.

The self-heating food box is proposed in the Korean Patent Application Publication No. 10-2012-0019767 (2012 Mar. 7), the related art has a disadvantage that all foods in the food box are heated when the food box is heated.

There are foods that should not be heated in the food box, so a disadvantage that heatable food and heatless food are separated and selectively heated still exists.

The present disclosure is provided for solve the above problems.

### SUMMARY

Accordingly, the present disclosure is intended to provide a lunch box container, which is selectively heated even when a lunch box wrapping is not removed.

Another objective of the present disclosure is intended to provide a lunch box container, which is heated unwrapped so as to reduce harm caused by fine dust generation and to reduce food smell during heating.

A further objective of the present disclosure is intended to provide a lunch box container, which reduces heating time and prevents moisture evaporation from food to keep the taste of food products.

In order to achieve the above objectives, the present disclosure has following configurations.

A first embodiment has a following configuration.

A lunch box container usable on an induction cooktop includes: a main container; and an auxiliary container configured to be accommodated in the main container, wherein the auxiliary container is made of a material heatable on an induction cooktop.

The auxiliary container may include a plurality of containers.

The auxiliary container may be an aluminum container or a container made of an aluminum film deposition paper.

A second embodiment has a following configuration.

A lunch box container usable on an induction cooktop may include: a main container; and a plurality of auxiliary containers configured to be accommodated in the main container, wherein the plurality of auxiliary containers comprises a first auxiliary container and a second auxiliary container, and the first auxiliary container is made of a material heatable on an induction cooktop and the second auxiliary container is made of a material that is not heatable on the induction cooktop.

The first auxiliary container may be an aluminum container or a container made of an aluminum film deposition paper.

The second auxiliary container may be one selected from a paper container, a PET container, and a PET-deposition paper container.

As described above, even when the lunch box container is heated unwrapped, foods can be selectively heated.

The lunch box container is heated unwrapped, so that harm caused by fine dust generation can be reduced and food smell can be reduced during heating foods.

Heating time can be shortened and moisture evaporation is prevented so that the taste of food can be preserved. The food is heated in the closed container so that heat loss can be prevented, and a box that is an outer wrapping is made of non-heating element and the box is prevented from being heated so that the user can be protected from a burn accident.

The lunch box container can be disposed by waste separation, so the lunch box container is eco-friendly.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a perspective view showing a main container and an auxiliary container of a separable and heatable lunch box container set of the related art.

FIG. 2 is a side view showing the separable and heatable lunch box container set of FIG. 1.

FIG. 3 is a front view showing a pouch of the separable and heatable lunch box container set.

FIGS. 4 and 5 are use-state views of the separable and heatable lunch box container set.

FIG. 6 is a perspective view showing a lunch box container of the present disclosure, wherein the lunch box container is configured to be heated at a desired portion thereof.

FIG. 7 is a view showing the lunch box container opened of FIG. 6.

FIG. 8 is a view showing auxiliary containers.

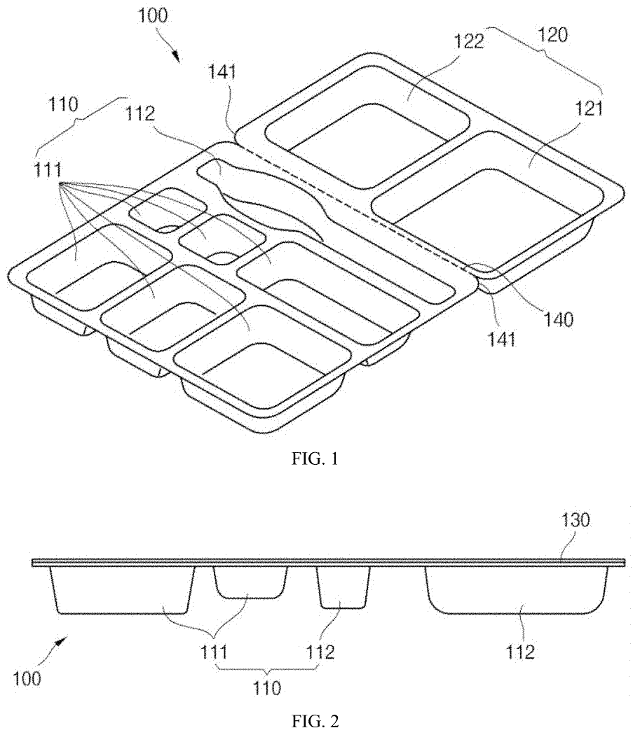

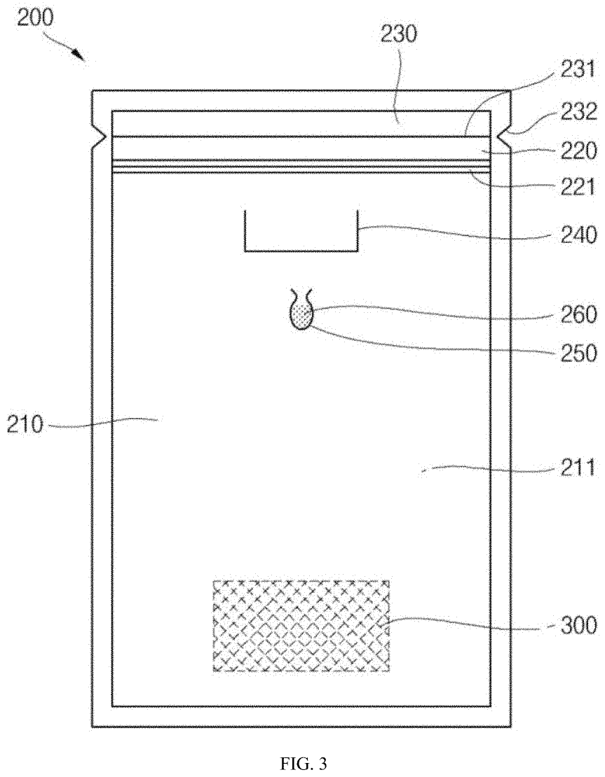

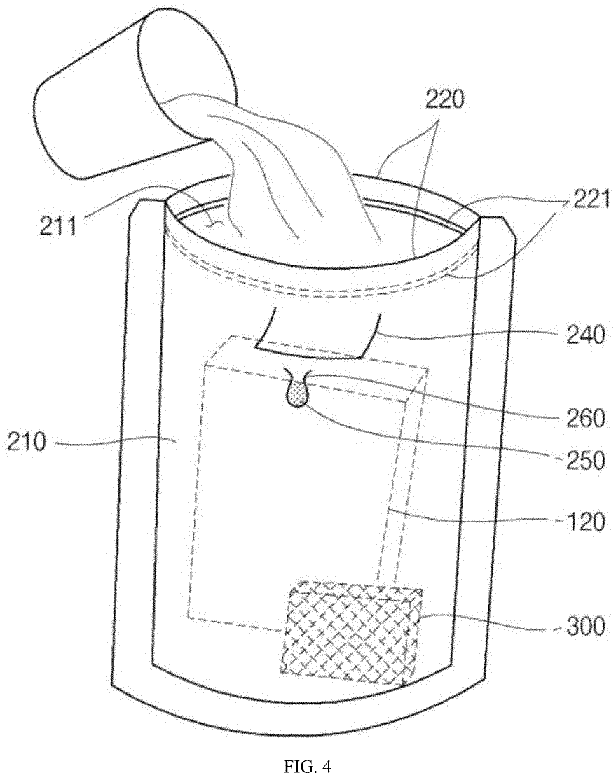

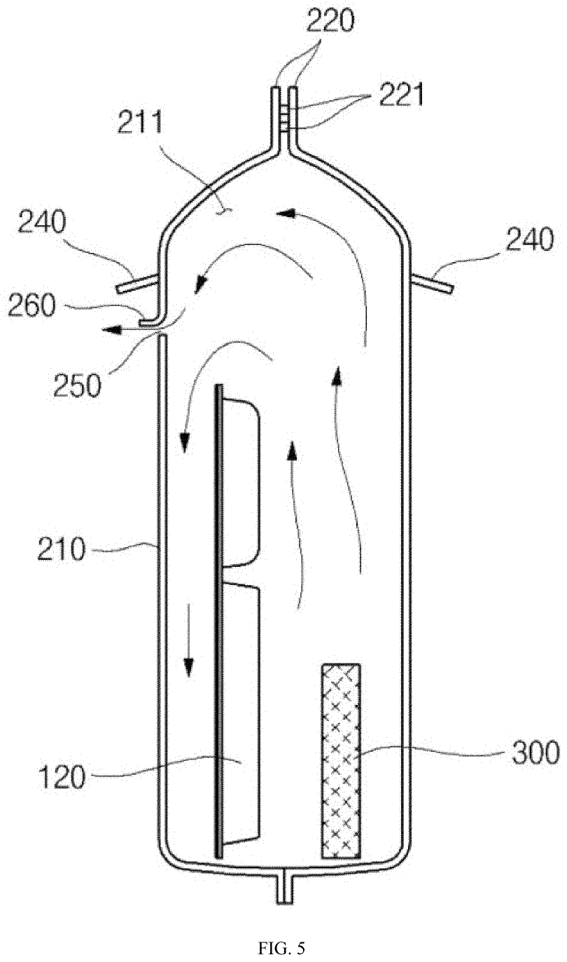

### DETAILED DESCRIPTION OF THE EMBODIMENTS

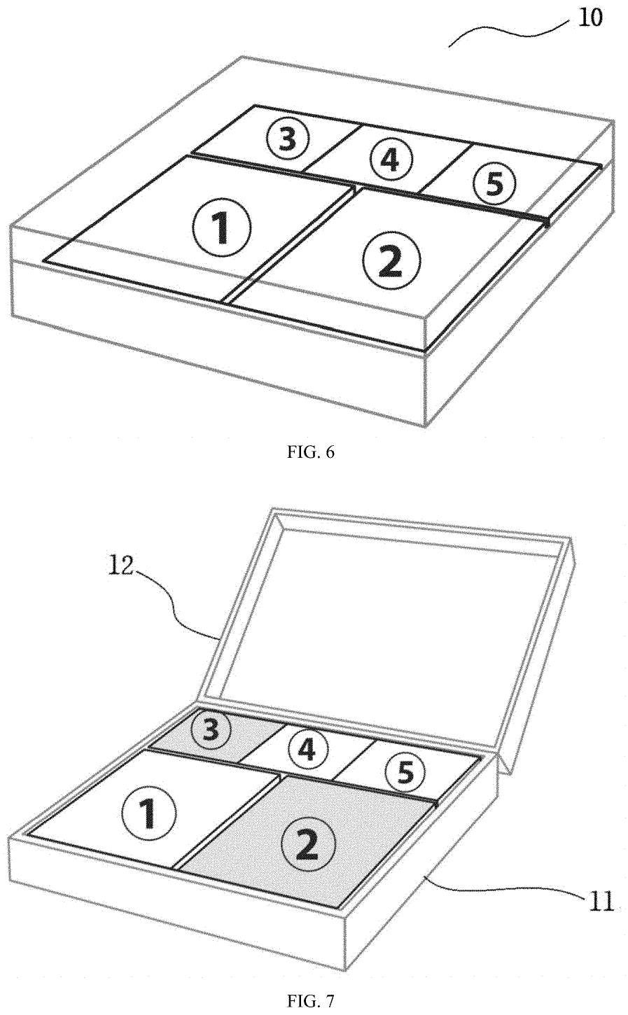

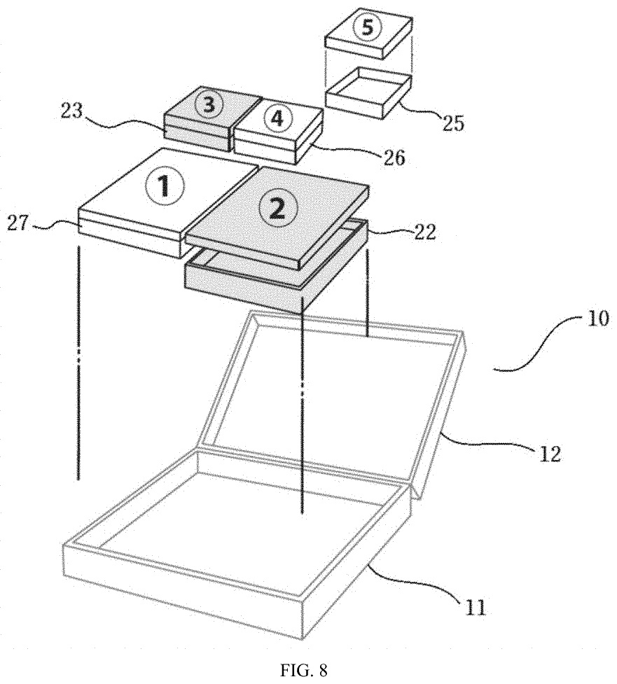

Hereinbelow, the present disclosure will be described with reference to FIGS. 6 to 8.

A lunch box container of the present disclosure includes: a main container 10; and an auxiliary container 22 configured to be accommodated in the main container 10, and the auxiliary container 22 is made of a material heatable on an induction cooktop.

The lunch box container may consist of only the auxiliary container heatable on the induction cooktop.

The auxiliary container 22, 23 may include a plurality of auxiliary containers and may store heatable food 2 and 3.

The heatable auxiliary containers 22 and 23 are preferably an aluminum container or a container made of an aluminum film deposition paper.

Frozen food may be defrosted and heated by being heated on the induction cooktop in an unwrapped lunch box, so a user can eat the food in the lunch box conveniently and use time may be shortened.

In general, many people order lunch boxes at one time.

Since the orders come at one time, the food should be stored in a frozen state in order to prepare the orders at regular times.

However, when the user eats the frozen food, the frozen food must be defrosted and heated, and in order to heat the food, it is inevitable that a wrapping of the lunch box is removed and the food that needs to be heated is separately heated.

When the user takes a frozen pizza home and heats the pizza, the user heats the pizza after removing a wrapping thereof, so the food does not taste good and may be cooked for a long time.

However, the lunch box container of the present disclosure is usable on the induction cooktop without removing a wrapping thereof so that the user can enjoy authentic taste of the food and does not cause fine dust.

When an induction cooktop is not in user's home, at a luncher, the lunch box may be sold after being immediately heated for 3 to 5 minutes, so the user can save the time and expensive.

A lunch box container according to a second embodiment of the present disclosure is configured to store heatable food and heatless food together.

The main container 10 is configured to partition the inside thereof with a plurality of auxiliary containers 22, 23, 25, 26, and 27.

The plurality of auxiliary containers 22, 23, 25, 26, and 27 includes first auxiliary containers 22 and 23 and the second auxiliary containers 25, 26, and 27.

The first auxiliary containers 22 and 23 are made of a material heatable on the induction cooktop and the second auxiliary containers 25, 26, and 27 are made of a material that is not heatable on the induction cooktop.

The first auxiliary containers 22 and 23 heatable on the induction cooktop consist of aluminum containers or containers formed of an aluminum film deposition paper.

However, any material heatable on the induction cooktop may be used as first auxiliary containers.

The second auxiliary containers 25, 26, and 27, which should not be heated on the induction cooktop, are one selected from a paper container, a PET container, and a PET-deposition paper container.

Most side dishes and fruits, such as kimchi and a fruit, lose the taste thereof when the food is heated.

The present disclosure is intended to provide the lunch box container is configured to allow heatable food and heatless food therein to be selective heated without removing a wrapping thereof.

To produce food, transport the food, and deliver the food to customers, a producer that produces lunch boxes, pizzas, or the like on a large scale incurs substantial labor and transportation costs.

The present disclosure is provided to solve the problems.

For example, assuming that daily consumption of a lunch box or pizza in a market is 100, the large scale food producer must provide 100 products to the market every day.

However, according to the present disclosure, depending on the capacity of a freezer, thousands of lunch boxes are delivered at one time and stored in the freezer, and when the lunch boxes are provided to consumers, the lunch box may be provided to consumers after being defrosted and heated without unwrapping. Therefore, there are advantages of reducing the labor cost due to unwrapping and repacking and reducing the transport cost due to frequent transporting of the lunch boxes.

Even when the market has many orders of lunch boxes at one time, lunch boxes that are stored in the freezer in advance may be defrosted and heated without unwrapping, so there is an advantage that the lunch boxes may be provided on time without the taste of the food being lost.

The present disclosure is invaluable for providing food that needs heating in addition to application to a lunch box for the user to eat the food.

Currently, the user takes packed food that is cooked already, heats the food secondarily, and then eats the food. However, the present disclosure can allow the user to heat a lunch box of which cooking is not finished on the induction cooktop and to eat the heated lunch box, thereby widening the range of the lunch box market.

The configuration as described above is eco-friendly because the present disclosure is disposed by waste separation.

When aluminum foil is used in the auxiliary container, the aluminum foil may be separated from the auxiliary container, so the lunch box container of the present disclosure is eco-friendly.

With the conventional lunch box, after purchasing the lunch box, the consumer needs to remove a wrapping vinyl of food in the lunch box, to defrost frozen foods, and then to heat the foods after putting the foods on a microwave-safe container, so heating and cooking the whole food takes a lot of time.

The present disclosure is simple, because the lunch box container of the present disclosure is heated while being placed on the induction cooktop without unwrapping. Therefore, the lunch box container of the present disclosure allows small requirements in manpower.

According to the present disclosure, the food is heated in the closed container, so that heating time is further shortened and moisture evaporation is prevented so that the taste of the food is preserved. Heat loss is prevented because the food is heated in the closed container, a box that is an external wrapping is made of a non-heating element so that an outer portion of the lunch box container is not heated to prevent a burn accident.

Furthermore, the lunch box container is eco-friendly because the lunch box container is disposed by waste separation.

The present disclosure has an effect of providing food at low cost because a large cost is reduced from the transport and labor costs.

Terms or words used in the specification and claims are not limited to meaning that is commonly understood by people or is defined in dictionaries, and should be interpreted as having a meaning that is consistent with meaning in the context of the relevant art.

Although the preferred embodiments of the present disclosure have been disclosed for illustrative purposes, those skilled in the art will appreciate that various modifications, additions and substitutions are possible, without departing from the scope and spirit of the invention as disclosed in the accompanying claims.

What is claimed is:

1. A lunch box container usable on an induction cooktop, comprising:
a main container; and
an auxiliary container configured to be accommodated in the main container,
wherein the auxiliary container is made of a material heatable on an induction cooktop.

2. The lunch box container of claim 1, wherein the auxiliary container comprises a plurality of containers.

3. The lunch box container of claim 1, wherein the auxiliary container is an aluminum container or a container made of an aluminum film deposition paper.

4. A lunch box container usable on an induction cooktop, comprising:
a main container; and
a plurality of auxiliary containers configured to be accommodated in the main container,
wherein the plurality of auxiliary containers comprises a first auxiliary container and a second auxiliary container, and
the first auxiliary container is made of a first material, wherein the first material is heatable on the induction cooktop; and the second auxiliary container is made of a second material, wherein the second material is not heatable on the induction cooktop.

5. The lunch box container of claim 4, wherein the first auxiliary container is an aluminum container or a container made of an aluminum film deposition paper.

6. The lunch box container of claim 4, wherein the second auxiliary container is one selected from the group consisting of a paper container, a PET container, and a PET-deposition paper container.

7. The lunch box container of claim 2, wherein the auxiliary container is an aluminum container or a container made of an aluminum film deposition paper.
